(19) United States
(12) Patent Application Publication
(10) Pub. No.: US 2024/0253203 A1
(43) Pub. Date: Aug. 1, 2024

(54) WORK MACHINE

(71) Applicant: Koki Holdings Co., Ltd., Tokyo (JP)

(72) Inventors: Kengo TAMURA, Ibaraki (JP); Koji SUZUKI, Ibaraki (JP)

(73) Assignee: Koki Holdings Co., Ltd., Tokyo (JP)

(21) Appl. No.: 18/561,277

(22) PCT Filed: Apr. 28, 2022
(86) PCT No.: PCT/JP2022/019286

§ 371 Date: Nov. 15, 2023

(30) Foreign Application Priority Data
May 19, 2021 (JP) 2021-084586

(51) Int. Cl. B25F 5/00; B25B 21/02

(52) U.S. Cl. CPC B25F 5/001; B25B 21/02

(57) ABSTRACT

In an impact wrench, a speed reduction mechanism includes a carrier part integrally formed at a rear end part of a spindle and a planetary gear rotatably supported on the carrier part, and the planetary gear is engaged with a pinion gear of a motor. Moreover, the speed reduction mechanism includes a bearing that rotatably supports the carrier part, and the bearing is configured on a radially outer side of a drive shaft of the motor with respect to the planetary gear. Thus, when compared to a configuration in which the carrier part is rotatably supported by the bearing configured on the front side or the rear side of the planetary gear, the size of the speed reduction mechanism in the front-rear direction is miniaturized, and in turn, the size of the impact wrench in the front-rear direction is miniaturized.

### TECHNICAL FIELD

The present invention relates to a work machine.

### RELATED ART

In the impact driver (work machine) described in Patent Document 1 below, a gear mechanism is provided on the front side of the rotary shaft of the motor, and the gear mechanism transmits the driving force of the motor to a tip end tool provided on the anvil. In addition, the gear mechanism includes a spindle provided on the front side of the rotary shaft, a planetary gear rotatably supported by the spindle and engaged with a pinion gear of the rotary shaft, an outer gear engaged with the planetary gear, and a bearing rotatably supports the spindle. That is, the gear mechanism is configured as a so-called planetary gear mechanism.

### RELATED ART DOCUMENT

### Patent Document

[Patent Document 1] Japanese Patent Application Laid-Open (JP-A) No. 2016-221621.

### SUMMARY OF INVENTION

### Technical Problem

Here, in the gear mechanism of the impact driver above, the bearing and the planetary gear are configured in line in the axial direction (front-rear direction) of the rotary shaft. Alternatively, the bearing is configured on the rear side in the axial direction (front-rear direction) of the rotary shaft with respect to the ring gear. As a result, the size of the impact driver in the axial direction of the rotary shaft tends to become larger. Further, in the work of the impact driver, the work is performed on the workpiece on the front side of the impact driver. Thus, when the impact driver's size in the front-rear direction becomes larger, the front and back distance between the impact driver and the workpiece becomes farer, which may reduce the workability of the impact driver.

The present invention aims to provide a work machine that may achieve miniaturization in consideration of the above facts.

### Solution to Problem

One or more embodiments of the present invention includes a work machine, including: a motor, having a drive shaft extending in an axial direction and a motor gear part provided in the drive shaft; a spindle, provided on one side in the axial direction of the motor; and a transmission mechanism, connected to the motor gear part and transmitting a rotational force of the drive shaft to the spindle to rotate the spindle. The transmission mechanism is provided with an idle gear, rotatably provided on the spindle and engaged with the motor gear part; a bearing, rotatably supporting the spindle and configured on a radially outer side of the drive shaft with respect to the idle gear.

In one or more embodiments of the present invention, the work machine is configured such that the transmission mechanism includes a support part formed on other side in the axial direction of the spindle, the idle gear is rotatably provided on the support part, and the bearing is configured to rotatably support the support part.

In one or more embodiments of the present invention, the work machine is configured such that the motor gear part, the idle gear, and the bearing are configured in line in a radial direction of the drive shaft.

In one or more embodiments of the present invention, the work machine is configured such that the support part includes a fitting part fitted into the bearing, and the fitting part and the idle gear are configured in line in a circumferential direction of the drive shaft.

In one or more embodiments of the present invention, the work machine is configured such that the transmission mechanism includes a ring gear in a ring shape engaged with the idle gear, and the ring gear is configured on the radially outer side of the drive shaft with respect to the idle gear and on the other side in the axial direction with respect to the bearing.

In one or more embodiments of the present invention, the work machine is configured such that the support part includes a first support part rotatably supported by the bearing; a second support part configured on the other side in the axial direction with respect to the first support part; and a support shaft, extended between the first support part and the second support part and rotatably supporting the idle gear.

In one or more embodiments of the present invention, the work machine is configured such that the bearing is fitted into a concave case that is open to the one side in the axial direction, and the first support part is provided with a regulating part, and movement of the bearing to the one side in the axial direction is regulated by the regulating part.

In one or more embodiments of the present invention, the work machine is configured such that the ring gear is configured on the radially outer side of the drive shaft with respect to the second support part.

In one or more embodiments of the present invention, the work machine is configured such that the idle gear includes a large diameter gear part engaged with the motor gear part and a small diameter gear part engaged with the ring gear and having a smaller diameter than the large diameter gear part.

In one or more embodiments of the present invention, the work machine is configured such that the bearing is configured on the radially outer side of the drive shaft with respect to the large diameter gear part.

In one or more embodiments of the present invention, the work machine is configured such that a work machine, including: a motor, having a drive shaft extending in an axial direction and a motor gear part provided in the drive shaft; a spindle, provided on one side in the axial direction of the motor; and a transmission mechanism, connected to the motor gear part and transmitting a rotational force of the drive shaft to the spindle to rotate the spindle. The transmission mechanism is provided with an idle gear, rotatably provided on the spindle and engaged with the motor gear part; a ring gear in a ring shape, engaged with the idle gear; and a bearing, rotatably supports the spindle and configured on the one side in the axial direction of the ring gear.

In one or more embodiments of the present invention, the work machine is configured such that the bearing rotatably supports the spindle and is configured on a radially outer side of the drive shaft with respect to the idle gear.

In one or more embodiments of the present invention, the work machine is configured such that the transmission mechanism includes a support part formed on other side in the axial direction of the spindle, the idle gear is rotatably provided on the support part, and the bearing is configured to rotatably support the support part.

In one or more embodiments of the present invention, the work machine is configured such that the idle gear includes a large diameter gear part engaged with the motor gear part and a small diameter gear part engaged with the ring gear and having a smaller diameter than the large diameter gear part.

In one or more embodiments of the present invention, the work machine is configured such that the bearing is configured on the radially outer side of the drive shaft with respect to the large diameter gear part.

### Effects of Invention

By one or more embodiments of the present invention, miniaturization is achieved.

### BRIEF DESCRIPTION OF DRAWING

FIG. 1 is a longitudinal cross-sectional view showing the impact wrench according to the embodiment.

FIG. 2 is a longitudinal cross-sectional view showing the enlarged view of the speed reduction mechanism shown in FIG. 1.

(A) of FIG. 3 is a cross-sectional view when viewed from the front side (cross-sectional view along the line 3A-3A of FIG. 2) showing the engagement state between the small diameter gear part of the planetary gear and the ring gear in the speed reduction mechanism shown in FIG. 2, and (B) is a cross-sectional view when viewed from the front side (cross-sectional view along the line 3B-3B in FIG. 2) showing the engagement state between the large diameter gear part of the planetary gear and the pinion gear of the motor shown in FIG. 2.

FIG. 4 is a perspective view of the spindle shown in FIG. 1 when viewed from the right diagonal rear.

FIG. 5 is a longitudinal cross-sectional view showing a variation of the speed reduction mechanism shown in FIG. 2.

### DESCRIPTION OF THE EMBODIMENTS

Hereinafter, an impact wrench 10 as a work machine according to the embodiment will be described using the drawings. The arrow UP, arrow FR, and arrow RH, indicated as appropriate in the drawings, indicate the upper, front, and right sides of the impact wrench 10, respectively. In the following description, when using directions such as up and down, front and rear, and left and right, unless otherwise specified, it refers to the up-down direction, front-rear direction, and left-right direction of the impact wrench 10. It should be noted that in the drawings, hatching is omitted for convenience of illustration.

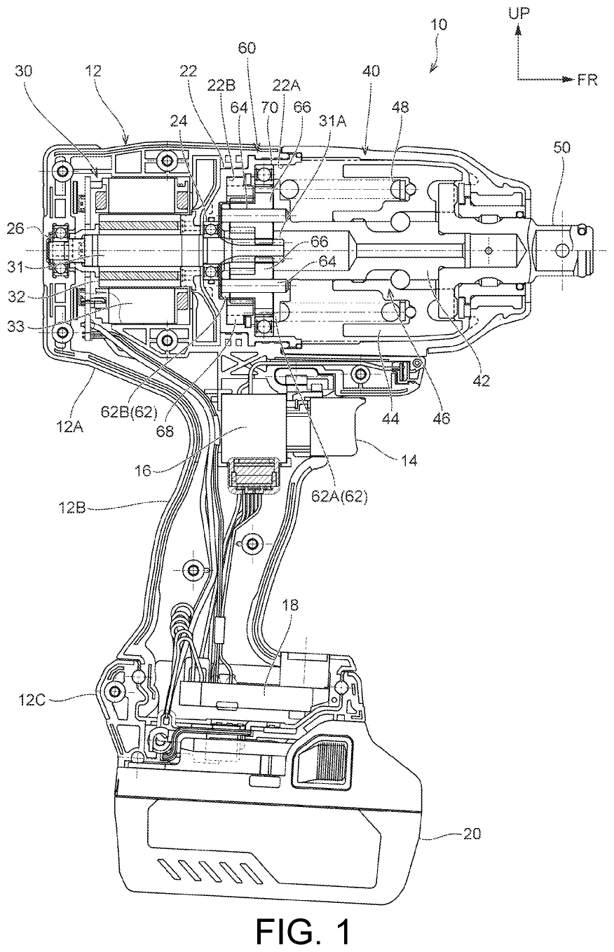

As shown in FIG. 1, the impact wrench 10 is configured as a tool that performs tightening processing and the like by applying rotational force and impact force to an anvil 50 provided at the front end part of the impact wrench 10. The impact wrench 10 includes a housing 12 that forms the outer shell of the impact wrench 10, a motor 30 accommodated in the housing 12, an impact mechanism 40, and a speed reduction mechanism 60 as a transmission mechanism. Each configuration of the impact wrench 10 will be described below.

(Regarding the housing 12) The housing 12 is formed into a hollow and substantially I-shape when viewed from the right side. In particular, the housing 12 includes an upper housing part 12A configuring the upper end part of the housing 12 and extends in the front-rear direction; a handle part 12B extends downward from the middle part of the upper housing part 12A in the longitudinal direction; and a lower housing part 12C configuring the lower end part of the housing 12. It should be noted that the housing 12 is configured of multiple housing members, and the housing 12 is formed by assembling these housing members to each other.

A trigger 14 is provided at the upper end part of the handle part 12B, and the trigger 14 is configured to protrude from the handle part 12B to the front side and may be pulled to the rear side. The handle part 12B is provided with a switch mechanism 16 on the rear side of the trigger 14. The switch mechanism 16 includes a switch that is not shown in the drawings, and when the trigger 14 is pulled, the switch is switched from off to on.

A controller 18 is provided in the lower housing part 12C. The switch of the switch mechanism 16 is electrically connected to the controller 18, and an output signal corresponding to the operation state of the trigger 14 is output from the switch to the controller 18. Further, a battery 20 is removably attached to the lower housing part 12C. The battery 20 is electrically connected to the controller 18 and supplies power to the motor 30, which will be described later, through the controller 18.

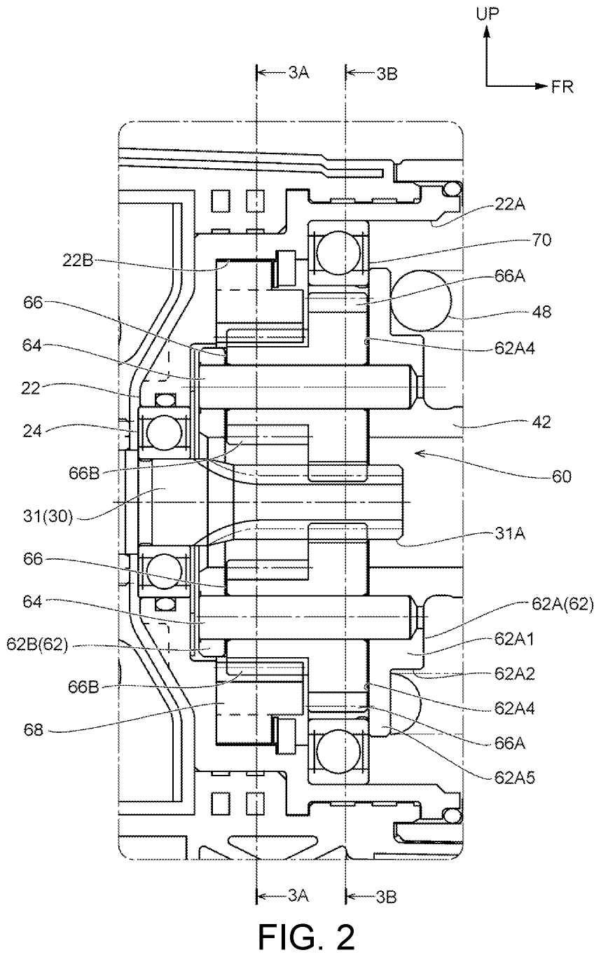

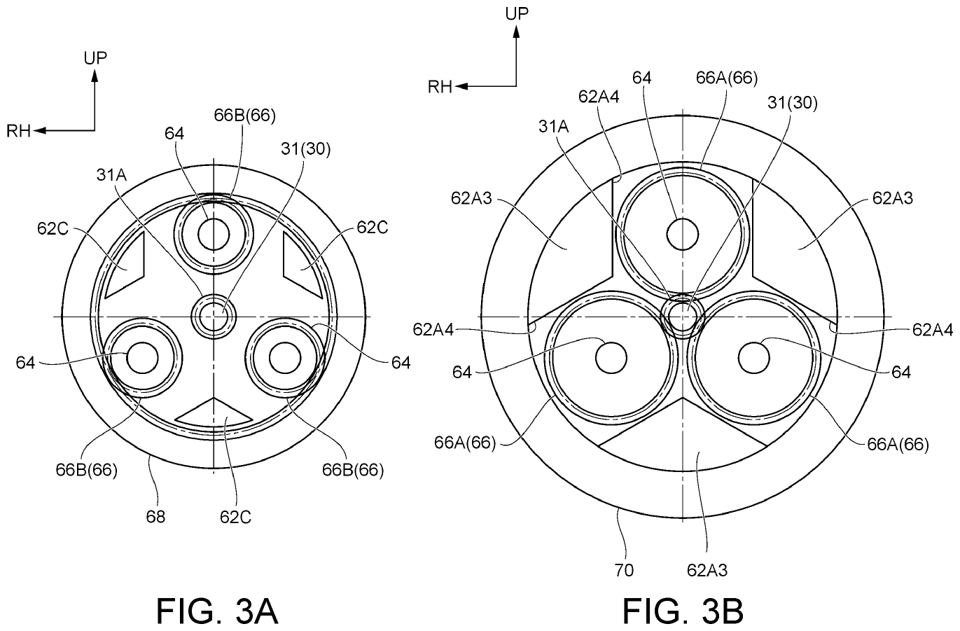

As shown in FIG. 2, an inner case 22 is provided in the upper housing part 12A as a case that accommodates the speed reduction mechanism 60, which will be described later. The inner case 22 is formed into a substantially bottomed cylindrical shape that is open to the front side and is configured in the middle part in the front-rear direction of the upper housing part 12A to be assembled to the housing 12. A motor bearing 24 for supporting a drive shaft 31 of the motor 30, which will be described later, is provided at the center of the bottom wall of the inner case 22. That is, a fixing hole that fixes the motor bearing 24 is formed on the bottom wall of the inner case 22. Moreover, the side wall of the inner case 22 is formed into a substantially stepped cylindrical shape, and the diameter dimension of the front part of the side wall is set larger than the diameter dimension of the rear part of the side wall. Then, the inner space at front part of the inner case 22 is configured as the first storage part 22A, and the inner space at the rear part of the inner case 22 is configured as the second storage part 22B.

(Regarding the motor 30) As shown in FIG. 1, the motor 30 is accommodated in the rear end part of the upper housing part 12A and is electrically connected to the controller 18. The motor 30 includes a drive shaft 31 with the front-rear direction as the axial direction, a rotor 32 that is integrally rotatably connected to the drive shaft 31, and a stator 33 formed in a substantially cylindrical shape and configured on the radially outer side of the rotor 32.

The rear end part of the drive shaft 31 is rotatably supported by a motor bearing 26 fixed to the housing 12. On the other hand, the front end side part of the drive shaft 31 is rotatably supported by the motor bearing 24 fixed to the inner case 22, and the front end part of the drive shaft 31 is accommodated in the inner case 22. At the front end part of the drive shaft 31, a pinion gear 31A is formed as a motor gear part. The pinion gear 31A is engaged with a large diameter gear part 66A of the planetary gear 66 in the speed reduction mechanism 60, which will be described later, and the rotational force of the motor 30 is transmitted to the spindle 42 by the speed reduction mechanism 60. Details of the speed reduction mechanism 60 will be described later.

(Regarding the impact mechanism 40) The impact mechanism 40 is configured as a well-known impact mechanism that applies rotational impact force to the anvil 50 provided at the front end part of the upper housing part 12A. Thus, the configuration of the impact mechanism 40 will be briefly described below. The impact mechanism 40 has a spindle 42. The spindle 42 is formed into a substantially stepped cylindrical shape having the front-rear direction as the axial direction. The spindle 42 is rotatably accommodated in the upper housing part 12A and is configured coaxially with the drive shaft 31 of the motor 30 and on the front side (one side in the axial direction) of the motor 30. The diameter dimension of the front part of the spindle 42 is set smaller than the diameter dimension of the rear part of the spindle 42. A carrier part 62 configuring a part of the speed reduction mechanism 60, which will be described later, is integrally formed at the rear end part of the spindle 42.

A substantially cylindrical hammer 44 is extrapolated to the front part of the spindle 42, and the hammer 44 is connected to the spindle 42 through a cam mechanism 46. Further, the anvil 50 is provided on the front side of the spindle 42, and a tip end tool (not shown) is mounted to the anvil 50. Then, the driving force of the motor 30 is transmitted to the impact mechanism 40 by the speed reduction mechanism 60, which will be described later, and the impact mechanism 40 is operated to apply rotational impact force to the anvil 50.

(Regarding the speed reduction mechanism 60) As shown in FIG. 1 to FIG. 3, the speed reduction mechanism 60 is accommodated in the upper housing part 12A and is configured between the motor 30 and the impact mechanism 40. Specifically, the speed reduction mechanism 60 is configured on the radially outer side of the pinion gear 31A of the motor 30. The speed reduction mechanism 60 is configured as a so-called planetary gear mechanism with the pinion gear 31A as the sun gear, which decelerates the rotation of the motor 30 and transmits the same to the impact mechanism 40. The speed reduction mechanism 60 includes the carrier part 62 as a support part integrally provided at the rear end part of the spindle 42, three planetary gears 66 as idle gears, a ring gear 68, and a bearing 70.

(Regarding the carrier part 62) As shown in FIG. 2 to FIG. 4, the carrier part 62 includes a first carrier part 62A as a first support part and a second carrier part 62B as a second support part. The first carrier part 62A and the second carrier part 62B are configured to face each other with a predetermined interval in the front-rear direction and is connected by a carrier connection part 62C.

The first carrier part 62A includes a base plate part 62A1 configuring the base of the first carrier part 62A. The base plate part 62A1 is formed into a substantially annular plate shape with the front-rear direction as the plate thickness direction, extends from the rear end part of the spindle 42 to the radially outer side, and is configured in the first storage part 22A of the inner case 22. A stepped part 62A2, which is one step down to the rear side, is formed in the outer circumferential part on the front surface of the base plate part 62A1, and the rear end part of an energizing spring 48 for energizing the hammer 44 of the impact mechanism 40 toward the front side is locked to the stepped part 62A2.

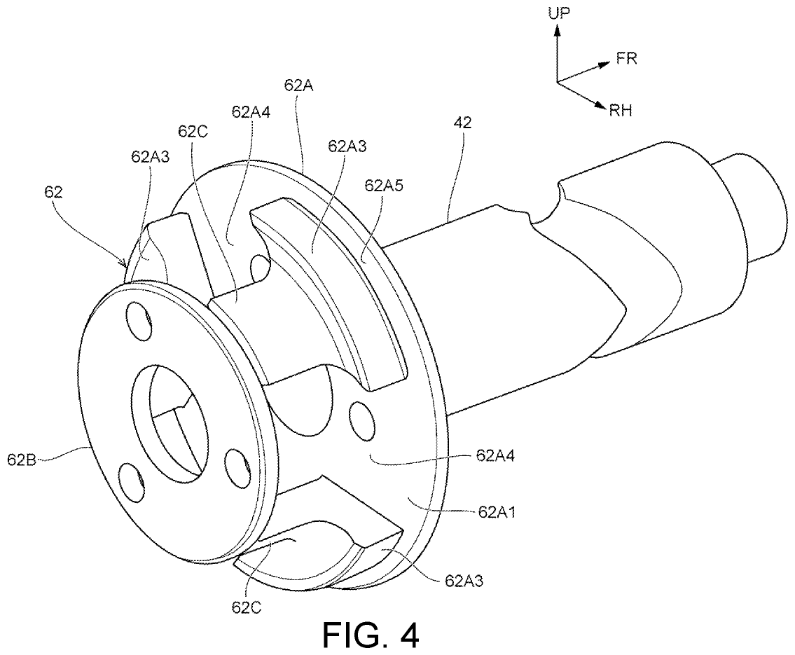

Three fitting parts 62A3 (see FIG. 3(B) and FIG. 4) are formed on the outer circumferential side part of the rear surface of the base plate part 62A1. The fitting parts 62A3 are formed into substantially fan shapes when viewed from the rear side and protrude from the base plate part 62A1 to the rear side. In addition, the arc part connecting the two sides of the fitting part 62A3, when viewed from the rear side, is configured to form a concentric circle with the outer circumferential surface of the base plate part 62A1, and the three fitting parts 62A3 are configured at equal intervals (every 120 degrees) in the circumferential direction of the spindle 42, with the axis of the spindle 42 as the center. As a result, in the first carrier part 62A, gear storage parts 62A4 are formed between adjacent fitting parts 62A3 in the circumferential direction of the spindle 42. The gear storage parts 62A4 are formed into a shape as a groove that is open to the rear side and extends in the radial direction of the base plate part 62A1. The three gear storage parts 62A4 communicates with each other in the center of the base plate part 62A1 and are open to the radially outer side of the base plate part 62A1. In addition, the outer circumferential part of the base plate part 62A1 (more specifically, the part configured outside than the fitting parts 62A3 in the radial direction) is configured as a regulating part 62A5. Then, the front part of the pinion gear 31A of the motor 30 described above is configured on the radically inner side of the first carrier part 62A.

The second carrier part 62B has a smaller diameter than the first carrier part 62A and is formed into a substantially annular plate shape with the front-rear direction as the plate thickness direction. The second carrier part 62B is configured coaxially with the first carrier part 62A on the rear side of the first carrier part 62A and connected to the first carrier part 62A by the carrier connection parts 62C extending from the fitting parts 62A3 of the first carrier part 62A to the rear side. The second carrier part 62B is configured close to the front side of the bottom wall of the inner case 22. The rear end part of the pinion gear 31A of the motor 30 described above is configured on the radically inner side of the second carrier part 62B.

Further, as shown in FIG. 2 and FIG. 3, each gear storage part 62A4 is provided with a support shaft 64 that rotatably supports the planetary gear 66, which will be described later. That is, in this embodiment, three support shafts 64 are provided in the carrier part 62. The support shafts 64 are formed into substantially columnar shapes with the front-rear direction as the axial direction. Then, the front end part parts of the support shafts 64 are fixed to the first carrier part 62A and the rear end part parts of the support shafts 64 are fixed to the second carrier part 62B, and the support shafts 64 are extended between the first support part 62A and the second support part 62B. The three support shafts 64 are configured at equal intervals (every 120 degrees) in the circumferential direction of the spindle 42.

(Regarding the planetary gear 66) The planetary gear 66 is configured as a two-stage gear with the front-rear direction as the axial direction and rotatably supported by the support shaft 64 of the carrier part 62. Specifically, the planetary gear 66 includes a large diameter gear part 66A configuring the front part of the planetary gear 66 and a small diameter gear part 66B configuring the rear part of the planetary gear 66. The large diameter gear part 66A and the small diameter gear part 66B are formed into a substantially circular cylindrical shape with the front-rear direction as the axial direction, and the diameter of the large diameter gear part 66A is set larger than the diameter of the small diameter gear part 66B. The outer circumferential parts of the large diameter gear part 66A and the small diameter gear part 66B are each formed with an external tooth configured by multiple teeth, and each external tooth is formed over the large diameter gear part 66A and the small diameter gear part 66B in the circumferential direction entirely. Then, the external tooth of the large diameter gear part 66A is engaged with the pinion gear 31A. That is, the large diameter gear part 66A is accommodated in the gear storage part 62A4 of the carrier part 62 and is configured in the first storage part 22A of the inner case 22. As a result, in the first carrier part 62A, the large diameter gear parts 66A of the planetary gear 66 and the fitting parts 62A3 are configured in line alternately in the circumferential direction of the first carrier part 62A (see FIG. 3(B)). On the other hand, the small diameter gear part 66B is configured on the radially outer side on the rear part of the pinion gear 31A and in the second storage part 22B of the inner case 22.

(Regarding the ring gear 68) The ring gear 68 is formed into an annular plate shape with the front-rear direction as the thickness direction. The ring gear 68 is configured coaxially with the drive shaft 31 of the motor 30 and on the radially outer side of the drive shaft 31 with respect to the small diameter gear part 66B of the planetary gear 66. Further, the ring gear 68 is fitted into the second storage part 22B of the inner case 22 and is held by the inner case 22 so as not to be relatively movable. The inner circumferential part of the ring gear 68 is formed with an inner tooth configured by multiple teeth, and the inner tooth is formed over the ring gear 68 in the circumferential direction entirely. The inner tooth of the ring gear 68 are engaged with the external tooth of the small diameter gear part 66B of the planetary gear 66. As a result, when the drive shaft 31 of the motor 30 rotates, the planetary gear 66 revolves in the circumferential direction of the ring gear 68 while rotating around the axis of the support shaft 64. As a result, the rotational force of the motor 30, which is decelerated by the speed reduction mechanism 60, is transmitted to the carrier part 62, so that the spindle 42 rotates around its own axis.

(About the bearing 70) The bearing 70 is configured as a ball bearing. The bearing 70 is fitted into the first storage part 22A of the inner case 22 and is held by the inner case 22 so as not to be relatively movable. Then, the fitting parts 62A3 of the first carrier part 62A in the carrier part 62 are fitted into the bearing 70 from the front side, and the carrier part 62 (spindle 42) is rotatably supported by the bearing 70. Further, the large diameter gear part 66A of the planetary gear 66 is configured in close proximity to the radically inner side part of the bearing 70 with a predetermined gap. Furthermore, in the fitting state of the fitting parts 62A3 into the bearing 70, the regulating part 62A5 of the first carrier part 62A is configured adjacent to the front side with respect to the radically inner side of the bearing 70 to regulate the movement of the bearing 70 to the front side by the regulating part 62A5. Furthermore, the bearing 70 is configured on the front side of the ring gear 68 in the axial direction. As a result, compared to the conventional case in which the bearing is configured on the rear side of the ring gear in the axial direction, the dead space between the fan provided on the front side of the motor 30 as the drive shaft and the inner case 22 in the axial direction may be packed, making the work machine more compact.

(Operation and effect) Next, the operation and effect of this embodiment will be described.

In the impact wrench 10 with the above configuration, when the trigger 14 is operated by the worker, the motor 30 is driven by the control of the controller 18, and the drive shaft 31 of the motor 30 rotates. When the drive shaft 31 rotates, the planetary gear 66 engaged with the pinion gear 31A of the drive shaft 31 rotates. The small diameter gear part 66B of the planetary gear 66 is engaged with the ring gear 68, and the ring gear 68 is non-rotatably held by the inner case 22. Thus, the planetary gear 66 revolves in the circumferential direction of the ring gear 68 while rotating around the axis of the support shaft 64. In this way, the carrier part 62 (i.e., spindle 42) is caused to rotate. Thus, the impact mechanism 40 is operated and a rotational impact force is applied to the anvil 50.

Here, the speed reduction mechanism 60 includes the carrier part 62 integrally formed at the rear end part of the spindle 42 and the planetary gear 66 rotatably supported on the carrier part 62, and the planetary gear 66 is engaged with the pinion gear 31A of the motor 30. Moreover, the speed reduction mechanism 60 includes the bearing 70 that rotatably supports the carrier part 62, and the bearing 70 is configured on a radially outer side of the drive shaft 31 of the motor 30 with respect to the planetary gear 66. Thus, when compared to a configuration in which the carrier part 62 is rotatably supported by the bearing 70 configured on the front side or the rear side of the planetary gear 66, the size of the speed reduction mechanism 60 in the front-rear direction is miniaturized, and in turn, the size of the impact wrench 10 in the front-rear direction is miniaturized. In this way, the front and back distance between the workpiece located on the front side of the impact wrench 10 and the worker located on the rear side of the impact wrench 10 may be shortened. Thus, the workability of the impact wrench 10 may be improved.

Further, the pinion gear 31A of the motor 30, the planetary gear 66, and the bearing 70 are configured in line in the radial direction of the drive shaft 31 of the motor 30. That is, the pinion gear 31A, the planetary gear 66, and the bearing 70 are configured at overlapping positions in the front-rear direction. In particular, the bearing is configured within a range from a front end to a rear end of the idle gear in the work machine according to claim 9. In this way, for example, when compared to a configuration in which the bearing 70 is shifted in the front-rear direction with respect to the pinion gear 31A and the planetary gear 66, the size of the speed reduction mechanism 60 in the front-rear direction is miniaturized, and in turn, the size of the impact wrench 10 in the front-rear direction is miniaturized.

In addition, the speed reduction mechanism 60 includes the ring gear 68, and the ring gear 68 is configured on the radially outer side of the drive shaft 31 with respect to the planetary gear 66 and on the rear side of the bearing 70. In this way, the ring gear 68 and the bearing 70 may be configured side by side in the front-rear direction. The size of the speed reduction mechanism 60 in the front-rear direction may be further miniaturized.

Further, the carrier part 62 of the spindle 42 includes the first carrier part 62A configuring the front end part of the carrier part 62, the second carrier part 62B configuring the rear end part of the carrier part 62, and the support shaft 64 pivotally supporting the planetary gear 66. The fitting parts 62A3 of the first carrier part 62A are fitted into the bearing 70 and is rotatably supported by the bearing 70. More specifically, in the first carrier part 62A, the fitting parts 62A3 and the planetary gear 66 are configured alternately in the circumferential direction, the fitting parts 62A3 are fitted into the bearing 70, and the planetary gear 66 is engaged with the pinion gear 31A of the motor 30. As a result, even if the bearing 70 is configured on the radially outer side of the drive shaft 31 with respect to the planetary gear 66, the carrier part 62 (spindle 42) may be rotatably supported by the bearing 70 while the planetary gear 66 is configured on the carrier part 62.

Moreover, the bearing 70 is held by the inner case 22, which is open to the front side. Furthermore, the regulating part 62A5 of the first carrier part 62A is configured adjacent to the front side on the radically inner side part of the bearing 70 and is configured to regulate the movement of the bearing 70 to the front side. In this way, by utilizing the carrier part 62, the holding state of the bearing 70 held by the inner case 22 may be maintained well.

Further, in the speed reduction mechanism 60, the ring gear 68 is configured on the radially outer side of the second carrier part 62B. As a result, the ring gear 68 is configured on the radially outer side of the drive shaft 31 with respect to the planetary gear 66, while the planetary gear 66 is configured on the carrier part 62.

Moreover, the planetary gear 66 of the speed reduction mechanism 60 includes the large diameter gear part 66A engaged with the pinion gear 31A and the small diameter gear part 66B engaged with the ring gear 68. In this way, the rotation of the motor 30 may be decelerated by the speed reduction mechanism 60 and transmitted to the spindle 42. This may contribute to the miniaturization of the motor 30. Thus, the impact wrench 10 may be effectively miniaturized.

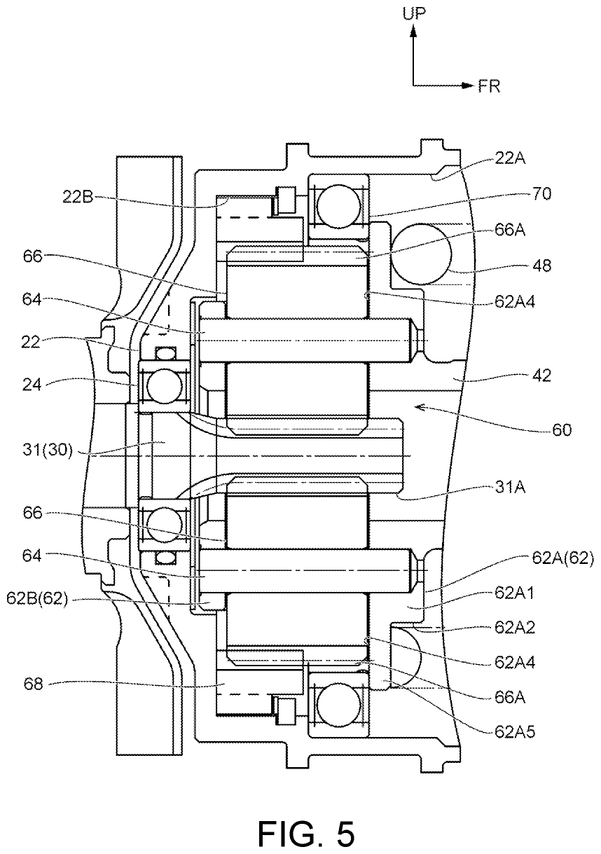

In this embodiment, the planetary gear 66 of the speed reduction mechanism 60 is configured as a two-stage gear, but the configuration of the planetary gear 66 is not limited thereto. For example, as shown in FIG. 5, the small diameter gear part 66B of the planetary gear 66 may be omitted and configured as a single stage gear in the planetary gear 66. In this case, the diameter dimension of the ring gear 68 may be made larger than that of this embodiment so that the external tooth on the rear part of the planetary gear 66 engages with the inner tooth of the ring gear 68. In this case, since the bearing 70 is configured on the radially outer side of the drive shaft 31 with respect to the planetary gear 66, compared to a configuration in which the bearing 70 is configured on the front side or the rear side of the planetary gear 66, the size of the speed reduction mechanism 60 in the front-rear direction may be miniaturized.

Further, in this embodiment, although the pinion gear 31A is integrally formed with the drive shaft 31 of the motor 30, the pinion gear 31A and the drive shaft 31 may be configured separately, and the pinion gear 31A may be connected to the drive shaft 31 so as to be integrally rotatable.

### REFERENCE SIGNS LIST

10 . . . Impact wrench (work machine); 22 . . . Inner case (case); 30 . . . Motor; 31 . . . Drive shaft; 31A . . . Pinion gear (motor gear part); 42 . . . Spindle; 60 . . . Speed reduction mechanism (transmission mechanism); 62 . . . Carrier part (support part); 62A . . . First carrier part (first support part); 62A3 . . . Fitting part; 62A5 . . . Regulating part; 62B . . . Second carrier part (second support part) 64 . . . Support shaft; 66 . . . Planetary gear (idle gear); 66A . . . Large diameter gear part; 66B . . . Small diameter gear part 68 . . . Ring gear; 70 . . . Bearing

1-15. (canceled)

16. A work machine, comprising:
a motor, having a rotor extending in an axial direction, a drive shaft integrally rotatably connected to the rotor and extending in the axial direction, and a motor gear part provided in the drive shaft;
a spindle, provided on one side in the axial direction of the motor; and
a transmission mechanism, connected to the motor gear part and transmitting a rotational force of the drive shaft to the spindle to rotate the spindle,
wherein the transmission mechanism comprises:
an idle gear, rotatably provided on the spindle and engaged with the motor gear part;
a bearing, rotatably supporting the spindle and configured on a radially outer side of the drive shaft with respect to the idle gear; and
a ring gear, having a ring shape and engaged with the idle gear,
wherein the transmission mechanism comprises a support part formed on other side in the axial direction of the spindle and supporting the idle gear, and
the support part comprises a fitting part configured in line in a radial direction of the motor gear part and the bearing and fitted with a radially inner side of the bearing.

17. The work machine according to claim 16, wherein the motor gear part, the idle gear, and the bearing are configured in line in the radial direction of the drive shaft.

18. The work machine according to claim 16, wherein the fitting part and the idle gear are configured in line in a circumferential direction of the drive shaft.

19. The work machine according to claim 16, wherein the idle gear is configured as a two-stage gear comprising a large diameter gear part engaged with the motor gear part and a small diameter gear part having a smaller diameter than the large diameter gear part,
wherein the ring gear is engaged with the small diameter gear part, and
the small diameter gear part and the ring gear is configured on the other side in the axial direction with respect to the large diameter gear part.

20. The work machine according to claim 19, wherein the bearing is configured on the one side in the axial direction with respect to the small diameter gear part and the ring gear.

21. The work machine according to claim 16, wherein the bearing is configured in line in the radial direction of the motor gear part.

22. The work machine according to claim 16, comprising:
an impact mechanism, connected to the transmission mechanism and generating a rotational impact force by transmitting a rotational force of the drive shaft,
wherein the impact mechanism comprises:
a spindle, provided on the one side in the axial direction of the motor;
a hammer, extrapolated to the one side in the axial direction of the spindle and connected to the spindle through a cam mechanism;
an energizing spring, energizing the hammer to the one side in the axial direction; and
an anvil, provided on the one side in the axial direction of the hammer,
wherein the support part comprises:
a first support part, rotatably supported by the bearing and locking the energizing spring;
a second support part, configured on the other side in the axial direction with respect to the first support part; and
a support shaft, extended between the first support part and the second support part and rotatably supporting the idle gear.

23. A work machine, comprising:
a motor, having a rotor extending in an axial direction, a drive shaft integrally rotatably connected to the rotor and extending in the axial direction, and a motor gear part provided in the drive shaft;
a spindle, provided on one side in the axial direction of the motor; and
a transmission mechanism, connected to the motor gear part and transmitting a rotational force of the drive shaft to the spindle to rotate the spindle,
wherein the transmission mechanism comprises:
a support part, formed on other side in the axial direction of the spindle;
an idle gear, rotatably provided on the support part and configured as a two-stage gear comprising a large diameter gear part engaged with the motor gear part and a small diameter gear part having a smaller diameter than the large diameter gear part;
a ring gear, having a ring shape and engaged with the idle gear; and
a bearing, rotatably supporting the spindle,
wherein the small diameter gear part and the ring gear is configured on the other side in the axial direction with respect to the large diameter gear part.

24. The work machine according to claim 23, wherein the motor gear part, the large diameter gear part, and the small diameter gear part are configured in line in a radial direction of the drive shaft.

25. The work machine according to claim 23, wherein the fitting part and the large diameter gear part are configured in line in a circumferential direction of the drive shaft.

26. The work machine according to claim 23, wherein the bearing is configured on the one side in the axial direction with respect to the small diameter gear part and the ring gear.

27. The work machine according to claim 23, wherein the bearing is configured in line in a radial direction of the motor gear part.

28. The work machine according to claim 23, comprising:
an impact mechanism, connected to the transmission mechanism and generating a rotational impact force by transmitting a rotational force of the drive shaft,
wherein the impact mechanism comprises:
a spindle, provided on the one side in the axial direction of the motor;
a hammer, extrapolated to the one side in the axial direction of the spindle and connected to the spindle through a cam mechanism;
an energizing spring, energizing the hammer to the one side in the axial direction; and
an anvil, provided on the one side in the axial direction of the hammer,
wherein the support part comprises:
a first support part, rotatably supported by the bearing and locking the energizing spring;
a second support part, configured on the other side in the axial direction with respect to the first support part; and
a support shaft, extended between the first support part and the second support part and rotatably supporting the idle gear.

29. A work machine, comprising:
a motor, having a rotor extending in an axial direction, a drive shaft integrally rotatably connected to the rotor and extending in the axial direction, and a motor gear part provided in the drive shaft;
an impact mechanism, generating a rotational impact force by transmitting a rotational force of the drive shaft;
a transmission mechanism, connected to the motor gear part and the impact mechanism and transmitting a rotational force of the drive shaft to the impact mechanism,
wherein the impact mechanism comprises:
a spindle, provided on one side in the axial direction of the motor;
a hammer, extrapolated to the one side in the axial direction of the spindle and connected to the spindle through a cam mechanism;
an energizing spring, energizing the hammer to the one side in the axial direction; and
an anvil, provided on the one side in the axial direction of the hammer,
wherein the transmission mechanism comprises:
a support part, formed on other side in the axial direction of the spindle;
an idle gear, rotatably provided on the support part;
a ring gear, having a ring shape and engaged with the idle gear; and
a bearing, rotatably supporting the spindle,
wherein the support part comprises:
a first support part, rotatably supported by the bearing and locking the energizing spring;
a second support part, configured on the other side in the axial direction with respect to the first support part; and
a support shaft, extended between the first support part and the second support part and rotatably supporting the idle gear.

30. The work machine according to claim 29, wherein the bearing is configured in line in a radial direction of the motor gear part.
